(19) United States
(12) Patent Application Publication
(10) Pub. No.: US 2007/0162330 A1
(43) Pub. Date: Jul. 12, 2007

(54) Method and apparatus for conducting a sweepstakes

(76) Inventors: Mark Olmstead, Denton, TX (US); Johnney R. Weaver, Weatherford, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/320,232

(22) Filed: Dec. 27, 2005

(51) Int. Cl. G06Q 30/00

(52) U.S. Cl. 705/14

(57) ABSTRACT

A personal identification card for use in a sweepstakes network is capable of being purchased for goods and services unrelated to a sweepstakes. The personal identification card includes a personal identification number associated with the personal identification card and readable and writeable digital storage means for storing digital data related to the sweepstakes and the goods and services unrelated to the sweepstakes.

### BACKGROUND

1. Field of the Invention

The present invention relates to a method and apparatus for conducting a sweepstakes. In particular, the present invention relates to a method and apparatus for conducting a sweepstakes in which a user purchases a multi-function personal identification card for goods and services unrelated to the sweepstakes, and in return, as a promotional bonus, is provided one or more entries into certain promotional sweepstakes games.

2. Description of Related Art

Sweepstakes, raffles, and lotteries have been around for centuries. People enjoy the experience of entering a sweepstakes and hoping to win the “grand” prize. In most sweepstakes, the participant purchases a ticket, or entry, for a nominal amount of money in exchange for a chance to win prizes that are valued significantly higher than the cost of the ticket. Most often, the odds of the participant of winning the best prizes are very high. However, to entice new participants to play, to keep participants interested in playing the sweepstakes, or to entice the participants to play the sweepstakes again, prizes having nominal values close to or below the cost of the entry are often awarded. The participant's odds of winning these nominally valued prizes are typically close to 1:1.

Although the sweepstakes industry is heavy regulated, it remains very large and lucrative. Indeed, with the advent in recent years of prepaid vouchers, such as prepaid gasoline cards, prepaid credit cards, and prepaid phone cards, new games of chance and methods of conducting sweepstakes have been developed. For example, one of these new games of chance involves the purchase of a $1.00 “emergency” prepaid phone card that provides about one minute of telephone airtime and an entry in a game of chance. In this example, a person inserts currency into a game terminal and, in return, receives a corresponding number of $1.00 “emergency” prepaid phone cards.

The prepaid phone cards used in these games are typically multi-layered or folded pieces of paper or cardboard that are preprinted and stored on a roll inside the game terminal. The prepaid phone cards used in these games are “read-only” devices that can only be read by card readers in the game terminal. Once these prepaid phone cards are printed, the data cannot be changed and no more data can be added. Certain indicia is printed on each $1.00 prepaid phone card, including a personal identification number (PIN) that is required to use the prepaid phone cards from any telephone, bar codes, and other graphical indicia that instruct the game terminal on what images to display and what prizes, if any, have been won. Thus, the “winning” and “losing” prepaid phone cards are predetermined.

One problem with these games is that each game terminal is a separate stand-alone machine. Because the prepaid phone cards are preprinted, there is no need or capability to interconnect or network the game terminals together. This greatly reduces the number, type, and style of games that can be played. In other words, the participants cannot choose between different games, cannot compete against each other on different game terminals, and cannot play the game over computer networks, such as the Internet. In addition, the game terminals cannot be monitored and maintained from a remote location over a computer network.

Another problem with these types of games of chance is that most participants purchase the prepaid phone card for the sole purpose of entering the game of chance, not to use the prepaid phone cards to buy telephone airtime. When the participant purchases the prepaid phone cards, he participates in the game of chance, whether he wants to or not. Because people only purchase these “emergency” prepaid phone cards to participate in the game, the regulatory authorities in many jurisdictions have determined that these games are illegal lotteries. The reasoning is that, because the prepaid phone card has a nominal value, the participants are giving consideration merely to play a game of chance, not to buy and use the prepaid phone cards to make telephone calls. This is evidenced by the fact that these $1.00 prepaid phone cards are often found unused in trash receptacles outside of establishments that sell such prepaid phone cards and offer such games of chance.

Although there have been great strides made in the area of conducting sweepstakes, many shortcomings remain.

### SUMMARY OF THE INVENTION

There is a need for a sweepstakes in which a user purchases a multi-function personal identification (PID) card for valuable goods and services unrelated to the sweepstakes, and, in return, receives one or more free game entries that can be used to participate in one or more sweepstakes-type games.

Therefore, it is an object of the present invention to provide an apparatus and method for conducting a sweepstakes in which a user purchases a multi-function PID card for valuable goods and services unrelated to a sweepstakes, and, on a transactional basis, is provided with a single optional entry into a first sweepstakes and a corresponding number of optional entries into other sweepstakes.

This object is achieved by providing a multi-function PID card that can be used as a prepaid voucher for valuable goods and services unrelated to a sweepstakes. The PID card is adapted to, for example: (1) identify the owner of the card via an account number; (2) identify a unique personal identification number and/or digitally store an activation code, for those embodiments in which the PID card serves as a prepaid voucher card, such as a prepaid phone card; (3) store and/or track optional entries and winnings for the various sweepstakes that may be available for participation by the user; and (4) store and/or track the number of minutes of phone airtime used by the user.

It is an another object of the present invention to provide a network for conducting a sweepstakes comprising a plurality of internet cafe sites capable of data communication with at least one purchased PID card for goods and services unrelated to the sweepstakes at the internet cafe. According to an advantageous embodiment of the present invention, the at least one PID card comprises a personal identification number associated with the PID card and a readable and writeable digital storage means for storing digital data related to the sweepstakes and the goods and services unrelated to the sweepstakes.

According to yet another embodiment of the present invention, the network for conducting a sweepstakes comprises at least one data center capable of data communication with the internet cafe and the PID card and at least one access system capable of data communication with the internet cafe, the data center, and the PID card.

It is still another object of the present invention to provide a method for conducting a sweepstakes including providing at least one PID card capable of being purchased for goods and services unrelated to a sweepstakes, providing a personal identification number associated with the PID card, and providing a readable and writeable digital storage means for storing digital data related to the sweepstakes and the goods and services unrelated to the sweepstakes.

According to still another embodiment of the present invention, the method for conducting a sweepstakes includes providing a plurality of internet cafe sites capable of data communication with the PID card, providing at least one data center for storing and retrieving data associated with the PID card and in data communication with the internet cafe, providing at least one access system capable of data communication with the internet cafe, the data center, and the PID card, and providing at least one point of sale terminal capable of data communication with at least one sweepstakes terminal associated with the internet cafe;

According to yet another embodiment of the present invention, the method for conducting a sweepstakes includes placing the sweepstakes terminals, the point of sale terminal, the internet cafe, the data center, the access system, and the means for activating and reactivating the PID card in data communication, providing an entry into a national sweepstakes and a corresponding number of entry units into a promotional sweepstakes, playing the sweepstakes in response to a sweepstakes selection at the sweepstakes terminal, and displaying the results of the sweepstakes selection on a video display of the sweepstakes terminal.

These and other advantages and features of the present invention will become readily apparent to those skilled in the art upon examination of the subsequent detailed description and accompanying drawings. Accordingly additional advantages and features of the present invention and the scope thereof are pointed out with particularity in the claims and form a part hereof.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 is a graphical representation of an exemplary sweepstakes network according to one embodiment of the present invention;

FIG. 2 is a graphical representation of the exemplary internet cafe of FIG. 1, according to one embodiment of the present invention;

FIG. 3 is a graphical representation of the exemplary data center of FIG. 1, according to one embodiment of the present invention;

FIG. 4 is a flowchart illustrating one particular method of operating a sweepstakes network according to the present invention; and

FIG. 5 is a flowchart illustrating the operation of an exemplary sweepstakes game according to one embodiment of the present invention.

### DETAILED DESCRIPTION OF THE PREFERRED EMBODIMENT

Reference will now be made to the following detailed description of the exemplary embodiments of the present invention. Those skilled in the art will recognize that the present invention provides many inventive concepts and novel features, that are merely illustrative, and are not to be construed as restrictive. Accordingly, the specific embodiments discussed herein are given by way of example and do not limit the scope of the present invention.

The present invention involves a method and apparatus for conducting a sweepstakes in which a user purchases a PID card for valuable goods and services unrelated to the sweepstakes. In return, as a promotional bonus, the user is provided an entry into a national sweepstakes and a corresponding number of optional entries into a promotional sweepstakes. The PID card may be redeemable for a wide variety of goods and services, and can take on many different forms, including a prepaid phone card, a prepaid internet card, a prepaid computer use card, a prepaid debit card, a gift certificate, a prepaid gasoline card, a prepaid credit card, or the like. In a preferred embodiment of the present invention, the PID card may be redeemed for about twenty minutes of telephone access time and/or thirty minutes of internet access time, and is sold for about $10.00 per card. It should be noted, however, that a PID card according to the present invention is not limited to a particular value or selling price. The scope of the present invention includes any PID card having a value greater than a nominal value and/or having a selling price greater than a nominal price. Although the present invention will be described with reference to a PID card, it should be understood that the PID card may be any suitable card, certificate, voucher, or the like that may be redeemed for valuable goods and/or services. In one embodiment, the PID card includes no visual indicia or advertising, either textual or graphic, regarding any sweepstakes (e.g., the national sweepstakes or the promotional sweepstakes).

One advantageous feature of the present invention is that the PID card be for “valuable” goods and services. This is one feature that distinguishes the present invention from prior-art sweepstakes, in which a voucher is redeemable for a nominal amount of goods or services, such as a $1.00 “emergency” card good for only one minute of telephone airtime. In such prior-art sweepstakes, it is common for participants to purchase the prepaid voucher for the sole purpose of entering the sweepstakes, not to use the prepaid voucher to buy airtime. This is evidenced by the fact that most of these $1.00 prepaid vouchers are found unused in trash receptacles proximate establishments that sell such vouchers and offer such sweepstakes. Because the PID cards used in the present invention preferably cost about $10.00 or more and are redeemable for about twenty minutes of airtime and/or thirty minutes of internet access time, they are considered to be PID cards, prepaid for “valuable” goods and services.

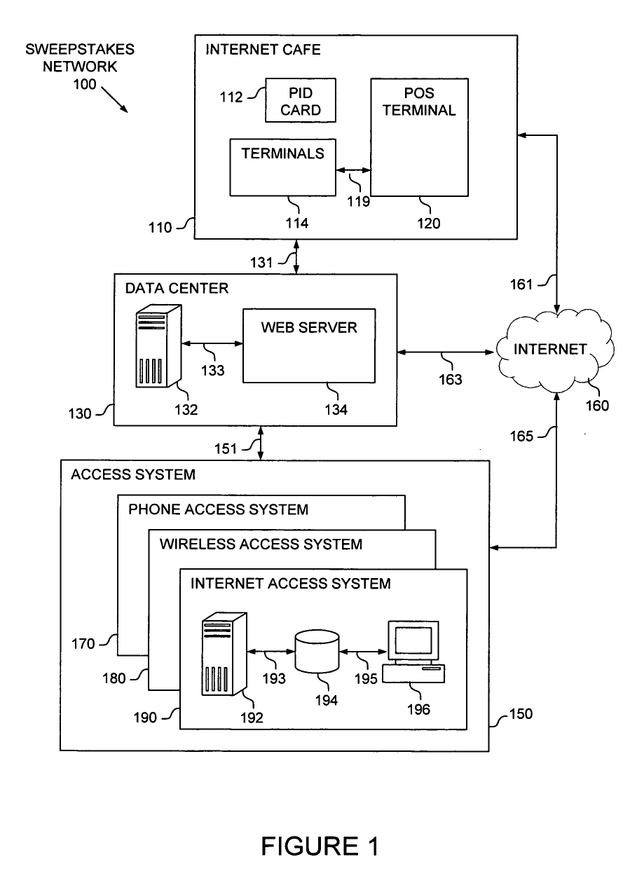

Referring now to FIG. 1 in the drawings, a preferred embodiment of a sweepstakes network 100 according to the present invention is illustrated. Sweepstakes network 100 comprises an internet cafe 110, a data center 130, an access system 150, and an internet 160. Internet cafe 110 comprises a plurality of terminals 114 and at least one point of sale (POS) terminal 120, networked together via a communication link 119. In addition, internet cafe 110 is networked via a communication link 131 to data center 130 and networked to the internet 160 via communication link 161. Additionally, internet cafe 110 further comprises at least one personal identification (PID) card 112, which is preferably similar to a credit card, including a digital storage means, such as a magnetic strip, located, for example, on the back of PID card 112. However, it should be understood that PID card 112 and the digital storage means may be any of a wide variety of digital storage devices, including diskettes, memory cards, memory sticks, or any other suitable digital data storage and transfer devices. Before PID card 112 can be redeemed for valuable goods and services, PID card 112 must be activated, as described in more detail below. Internet cafe 110 may be, for example, any point-of-sale retail site offering goods and/or services to users, including phone supplies, wireless access, computer use or the like.

Data center 130 comprises a database server 132 and a web server 134, networked together via a communication link 133. In addition, data center 130 is networked via communication link 131 to internet cafe 110, networked via communication link 151 to access system 150, and networked to the internet 160 via communication link 163.

Access system 150 comprises one or more access systems, such as, for example, phone access system 170, wireless access system 180, and internet access system 190. The scope of the present invention, however, encompasses other additional or alternative access systems within access system 150. In addition, access system 150 is networked via communication link 151 to data center 130 and networked to the internet 160 via communication link 165. In the illustrated embodiment, internet access system 190 comprises database server 192, database 194, and management terminal 196. In addition, database server 192 is networked via communication link 193 to database 194 which is networked via communication link 195 to management terminal 196. Additionally, phone access system 170 and wireless access system 180 each may comprise a database server (not shown), a database (not shown), and a management terminal (not shown), similar to those shown and described in relation to internet access system 190.

In addition, internet cafe 110 may be networked together, and may be networked to data center 130, access system 150, or both, by communication links 131 and 151 or communication links 161, 163, and 165 via internet 160. Communication links 119, 131, 133, 151, 161, 163, 165, 193 and 195 may comprise modems, telephone lines, the Internet, satellites, wireless connections, or any combination thereof for sending and receiving digital data and signals. Communication links 119, 131, 133, 151, 161, 163, 165, 193 and 195 provide a fast, efficient, reliable, and secure means for transferring digital data between internet cafe 110, data center 130, access system 150 and internet 160.

In one embodiment of the present invention, selected data is periodically transferred back and forth between internet cafe 110 and data center 130 via communication link 131. For example, the number of person identification numbers (PINs) available for activation and the number, type, and amount of accumulated transactions may be reported by each internet cafe 110 to at least one data center 130 at a predetermined basis, i.e. an hourly basis. If the number of PINs available at one internet cafe 110 reaches a predetermined number, then data center 130 transfers more PINs to that internet cafe 110. This periodic polling of internet cafe 110 ensures that data center 130 always has enough computing capacity to continuously conduct and control the sweepstakes games. In addition, internet cafe 110 may be polled or alternatively may send the data periodically to at least one data center 130.

It will be appreciated that in alternate embodiments the functions and operations of internet cafe 110, data center 130, access system 150, and internet 160 may be combined in different configurations into one or more networks and/or one or more servers located either at internet cafe 110 or remote from internet cafe 110.

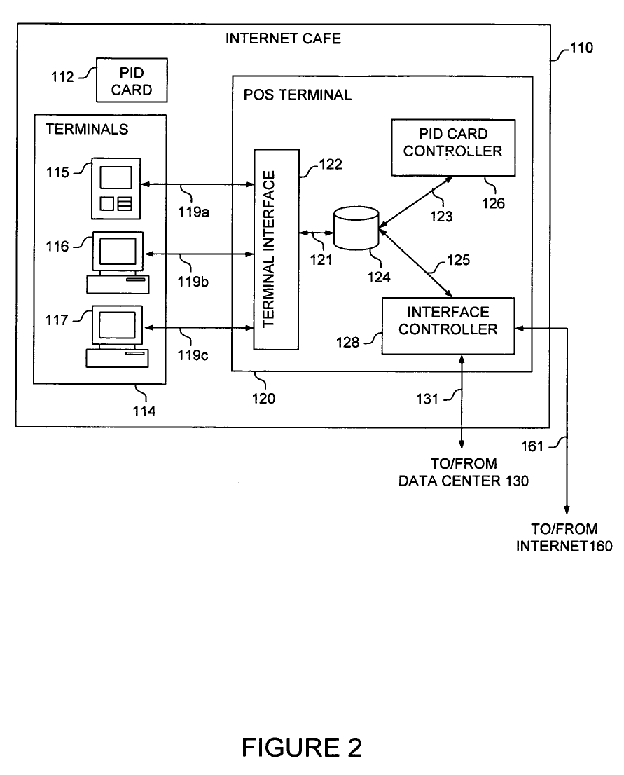

Referring now to FIG. 2 in the drawings, the preferred embodiment of internet cafe 110 according to the present invention is illustrated in greater detail. Internet cafe 110 comprises at least one PID card 112 and a plurality of terminals 114 networked together via communication links 119a-119c to at least one point of sale (POS) terminal 120. The plurality of terminals 114 comprises at least one recharge terminal 115 networked with at least one POS terminal 120 through terminal interface 122 via communication link 119a. In addition, the plurality of terminals 114 further comprises at least one sweepstakes terminal 116 and 117 networked with at least one POS terminal 120 through terminal interface 122 via communication link 119b and 119c respectively. POS terminal 120 comprises terminal interface 122, database server 124, PID card controller 126 and interface controller 128.

Terminal interface 122 is networked with the plurality of terminals 114 via communication link 119 and further networked with database server 124 via communication link 121. Terminal interface 122 provides for communicating with various network protocols and platforms of the plurality of terminals 114 to database server 124. Database server 124 is networked with PID card controller 126 via communication link 123 and with interface controller 128 via communication link 125. Interface controller 128 is networked via communication link 131 to data center 130 and networked to internet 160 via communication link 161.

POS terminal 120 provides for the activation of at least one PID card 112 for: (1) selling prepaid access time including phone time, internet access time, computer time and the like; (2) sales of other products and merchandise located either at internet cafe 110 or through internet 160; (3) generating free sweepstakes entries into the national sweepstakes; (4) awarding promotional sweepstakes points; and (5) redeeming winning points at the internet cafe 110 location. For this purpose, PID card controller 126 is operably associated with each POS terminal 120 for reading and writing digital data to the digital storage means located on or within each PID card 112. Before PID card 112 can be used to place telephone calls, access the internet, or the like, PID card 112 must be activated. Activation of PID card 112 is performed by placing PID card 112 into PID card controller 126 and writing a personal identification number (PIN) to the digital storage means, e.g., a magnetic strip. In an alternative embodiment, PID card 112 may comprise a miniature transponder programmable means of storing digital data rather than a magnetic strip, whereby activation of PID card 112 is performed by the contactless feature of the miniature transponder of PID card 112. Thus, PID card 112 is placed in close proximity to PID card controller 126 rather than inserting or swiping PID card 112 into PID controller 126. PID card controller 126 writes a PIN to PID card 112 and emits a signal, tone, or other such audible or visual annunciation to confirm the activation of PID card 112.

It will be appreciated that it is not necessary that PID card 112 be used at the same internet cafe 110 at which PID card 112 was purchased. Should the user choose to participate in a sweepstakes, PID card 112 may be used at any time and at any internet cafe 110, provided PID card 112 has not expired (for instances in which PID card 112 includes an expiration date). It will be further appreciated that the data communication between PID card 112 and the other component of internet cafe 110 may be performed by means other than card readers. For example, PID card 112 or the other components of internet cafe 110 may be adapted to send and receive data via wireless transmissions, such as infrared connections or other suitable wireless connections.

In addition, POS terminals 120 may be networked together, and may be networked to data center 130, access system 150, or both, by communication link 131 or communication links 161, 163, and 165 via internet 160. Communication links 119a-119c, 121, 123, 125, 131, 161, 163, and 165 may comprise modems, telephone lines, the Internet, satellites, wireless connections, or any combination thereof for sending and receiving digital data and signals. Communication links 119a-119c, 121, 123, 125, 131, 161, 163, and 165 provide a fast, efficient, reliable, and secure means for transferring digital data between POS terminals 120, PID cards 112, recharge terminals 115, sweepstakes terminals 116 and 117, data center 130, and access systems 150.

Additionally, POS terminal 120 provides a hub for recharge terminals 115 and sweepstakes terminals 116 and 117 and performs various other site-related functions. For example, POS terminal 120 manages the PINs, manages the sweepstakes game entries, maintains and provides accounting information for internet cafe 110, contains the finite promotional sweepstakes play information, and transmits the sweepstakes game entries to the sweepstakes terminals 116 and 117 for display to the user.

In the preferred embodiment of the present invention, the plurality of terminals 114 may include one or more recharge terminals 115. Each recharge terminal 115 is networked via a communication link 119a to at least one POS terminal 120 located at internet cafe 110. Each recharge terminal 115 includes a PID card controller (not shown) and a currency reader (not shown). Recharge terminal 115 allows the user to purchase additional access time for PID card 112 without going up to POS terminal 120. The user simply inserts PID card 112 into the PID card controller; inserts currency, either credit, debit, paper, or coin, into the currency reader; and selects an amount of access time to be added to PID card 112. It is not necessary that all of the access time on PID card 112 be used up before more access time is added. After the user inputs the amount of additional access time desired, the PID card controller updates PID card 112 by digitally writing the necessary digital data to the digital storage means of PID card 112. With each recharge of additional access time, PID card 112 is updated with a corresponding entry into the national sweepstakes and a number of free entries into the optional promotional sweepstakes. Recharge terminals 115 are the only machines in internet cafe 110 that include currency readers for accepting money. It is an important feature of the present invention that the user may not participate in any sweepstakes from any recharge terminal 115.

In one advantageous embodiment of the present invention, the plurality of terminals 114 may include at least one sweepstakes terminal 116 or 117. Each sweepstakes terminal 116 or 117 includes a PID card controller (not shown); a microprocessor; input devices such as keyboard, mouse, or touch screen video display; and output devices such as a video display, speakers, or lights. Sweepstakes terminal 116 may be for example an older version 8-liner gaming machine, whereas sweepstakes terminal 117 may be, for example, a newer version microprocessor based sweepstakes terminal. The PID card controller allows the microprocessor to read the digital data from the storage means associated with PID card 112 and write digital data back to the digital storage means of PID card 112. Upon insertion of PID card 112, PID card controller reads at least the following digital data from the digital means: the number of minutes of access time currently available on PID card 112; the number of entries into the national sweepstakes; the number or amount of promotional sweepstakes entry units available on PID card 112; the number or amount of credits or “wins” currently available on PID card 112; and the PIN, for validation purposes. When the user chooses to end the gaming session, the PID card controller writes updated digital data to the digital means of PID card 112.

It will be appreciated that in alternate embodiments the functions and operations of POS terminal 120, PID card 112, recharge terminal 115, and sweepstakes terminals 116 and 117 at internet cafe 110 may be combined in different configurations into one or more computers or stations located either at internet cafe 110 or remote from internet cafe 110. In addition or as an alternative, a wireless communications device capable of accessing the Internet may be used as a remote sweepstakes terminal. As an example and not by way of limitation a wireless communications device may be a wireless mobile phone, a video cell phone, a wireless laptop computer, or any other like wireless device.

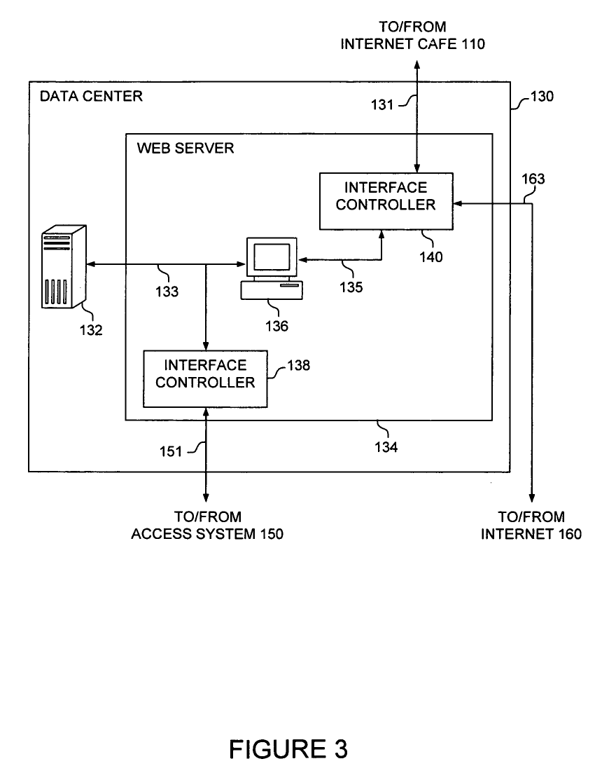

Referring now to FIG. 3 in the drawings, an exemplary data center 130 according to the present invention is illustrated in greater detail. Data center 130 comprises database server 132 networked together via communication link 133 to web server 134. Web server 134 comprises web server terminal 136 and interface controller 138 and 140. Web server terminal 136 is networked with interface controller 138 via communication link 133. In addition, web server 136 is networked with interface controller 140 via communication link 135.

Additionally, web server 134 may be networked to internet cafe 110, access system 150, or both, by communication links 131 or 151 respectively or communication links 161, 163, and 165 via internet 160. Communication links 131, 133, 135, 151, and 163 may comprise modems, telephone lines, the Internet, satellites, wireless connections, or any combination thereof for sending and receiving digital data and signals. Communication links 131, 133, 135, 151, and 163 provide a fast, efficient, reliable, and secure means for transferring digital data between database server 132, web server 134, web server terminal 136, interface controller 138 and 140, internet cafe 110, and access system 150.

In the preferred embodiment of the present invention, programming for the sweepstakes game is performed entirely on web server terminal 136. Data center terminal 136 stores, tracks, and maintains prize distribution tables for all sweepstakes games currently being played, including the national sweepstakes and the optional promotional sweepstakes. In one embodiment, web server terminal 136 is capable of storing about 40 million sweepstakes game plays. When all possible plays in a particular sweepstakes have been played, a new sweepstakes game is initiated. Thus, for example, sweepstakes terminal 115 of FIG. 2 functions primarily as a means of accepting the sweepstakes entries from PID card 112, displaying the results to the user, and updating the digital data on PID card 112 upon completion of a sweepstakes gaming session. In other words, although the user enters the sweepstakes game selections and plays the sweepstakes from sweepstakes terminal 115, the actual calculations and determinations of winning combinations are performed remotely by web server terminal 136.

In one advantageous embodiment of the present invention, web server terminal 136 publishes a sweepstakes training manual to at least one internet cafe 110 via communication link 131 or communication links 163 and 165 via internet 160. To further explain the operation of the sweepstakes training manual, an example is now given. In the following example, the operator of POS terminal 120 of FIG. 2 must read the sweepstakes training manual; then take and pass a test in order to operate POS terminal 120 associated with the tested sweepstakes games. In order to access the sweepstakes training manual, POS terminal 120 uses communication link 131 or 161 via internet 160 to access, read, and take the sweepstakes training manual test. If the operator of POS terminal 160 passes the test, then access is allowed to operate POS terminal 120 associated with the tested sweepstakes games. If the operator of POS terminal 160 fails the test, then access is denied to operate POS terminal 120 associated with the tested sweepstakes games until the operator successfully passes the test.

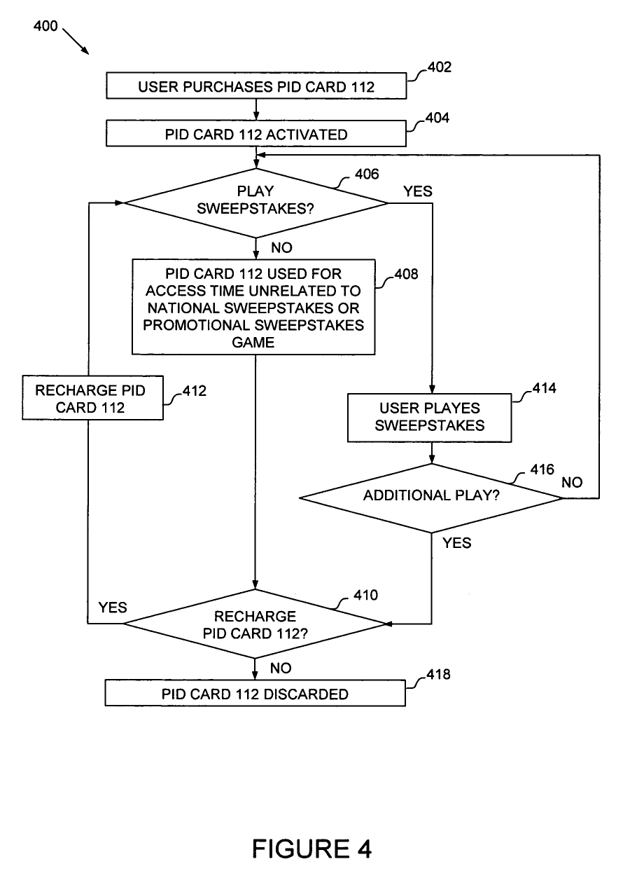

Referring now to FIG. 4 in the drawings, the preferred embodiment of a method for operating a sweepstakes network 400 according to the present invention is illustrated. The present invention starts at step 402 with a user purchasing a PID card 112 for valuable goods and services. The PID card 112 may be, for example, a blank card that is capable of being activated for any amount of access time, i.e. $5.00, $10.00 or the like. Alternatively, PID card 112 may be a pre-loaded and pre-activated card that is preprogrammed with the amount of access time available and a recommended purchase price, i.e. $5.00, $10.00 or the like, including, in some embodiments, a predetermined expiration date.

Next, in step 404, PID card 112 is activated by an operator of POS terminal 120 at internet cafe 110. In the alternative, a PID card 112 may be purchased at a non-internet cafe 110 site, for example, a gas station, a video store, a truck stop, or the like. In activation step 404, the operator inserts PID card 112 into PID card controller 126. PID card controller 126 reads selected digital data from the digital storage means located on PID card controller 126, and then writes selected data back to the digital storage means. The data written to PID card controller 126 includes a personal identification number (PIN), and may include other digital data, such as the amount of access time available and the purchase price paid by the user for PID card controller 126. Once the operator activates PID card 112 by writing the PIN to the digital storage means, the user is free to utilize the access time by placing telephone calls from any telephone until the telephone access time is used up, accessing the internet from any internet connection until the internet access time is used up, or by using a computer from any internet cafe 110 location until the computer access time is used up.

In accordance with the present invention, for each dollar amount access time purchased by the user, an entry into the national sweepstakes and a corresponding number of free entry units into the promotional sweepstakes is provided. This number of free entries may be written to PID card 112, or may be merely calculated by the appropriate sweepstakes terminal, POS terminal 120, and/or data center 130 at the appropriate time. These free entries are updated and made available each time PID card 112 is “recharged” or “reloaded,” as will be explained below. One feature of the present invention is that there is no charge for the entry into the national sweepstakes or for the entry units for the sweepstakes game. Thus, there is no charge to the user to participate in the sweepstakes. Participation in the sweepstakes is purely optional, and at no cost or loss to the consumer.

Then, in inquiry step 406, the user decides whether to participate in the optional sweepstakes. It is an important feature of the preferred embodiment of the present invention, that participation in the national sweepstakes or promotional sweepstakes game is optional. It is not necessary that the user participate in the sweepstakes, and the user does not participate in the sweepstakes merely by purchasing PID card 112. It is preferred that the optional sweepstakes be used as a promotional tool to promote sales of the access time associated with PID card 112. Thus, PID card 112 may be used to place telephone calls, access the Internet, or access computer time regardless of whether the user chooses to participate in the sweepstakes.

If the user decides not to participate in the national sweepstakes or the promotional sweepstakes, the procedure proceeds to step 408. In step 408, the user uses the activated PID card 112 to purchase the goods and services for which it was purchased. Thus, the user is free to use free to utilize the access time on PID card 112 by placing telephone calls from any telephone until the telephone access time is used up, accessing the Internet from any Internet connection until the Internet access time is used up, or by using a computer from any internet cafe 110 location until the computer access time is used up. PID card 112 typically includes instructions for the user on how to use PID card 112 and how and when to enter the PIN. Once the user has expended all of the allotted access time on PID card 112, the procedure continues with a second inquiry step 410, in which the user decides whether to recharge or reload PID card 112.

Inquiry step 410 is necessary, because in the preferred embodiment of the present invention, PID card 112 is capable of being recharged or reloaded with additional access time, if the user decides to purchase such additional access time. If the user does not wish to purchase additional access time, then the procedure concludes at step 418, in which the consumer may discard used PID card 112. On the other hand, if the user decides to purchase additional access time, the procedure passes from inquiry step 410 to a recharge step 412. There are several ways in which the user may recharge PID card 112 with additional access time. First, the consumer may present PID card 112 to the operator at POS terminal 120, who then inserts PID card 112 into PID card controller 126 of POS terminal 120 and reactivates PID card 112 with the amount of additional access time purchased. Second, the user may insert PID card 112 into any one of recharge terminals 115 and reactivate PID card 112 by inserting an appropriate amount of currency into the currency reader. Third, the user may convert his winnings into additional access time by depressing the portion of the video display of sweepstakes terminal 117 that is displaying a graphical image depicting, for example “Buy Additional Access Time” at an appropriate time during a sweepstakes game session.

Regardless of the recharge method chosen, once PID card 112 is updated and reactivated, the consumer may again use PID card 112 to place telephone calls, access the Internet, or access computer time. Reactivation step 412 may include writing a new PIN, an additional entry into the national sweepstakes and an additional corresponding number of free entries into the promotional sweepstakes to the digital storage means of PID card 112. As is shown, the procedure then passes back to inquiry step 406, in which the user again decides whether to participate in the promotional sweepstakes.

It is an important feature of the present invention that the consumer may only purchase access time. Sweepstakes game entries are only provided as a result of a purchase of access time. The user may not directly purchase sweepstakes game entry units. The user is not charged to participate in the game, nor is the user's valuable goods and services diminished by participation in the game.

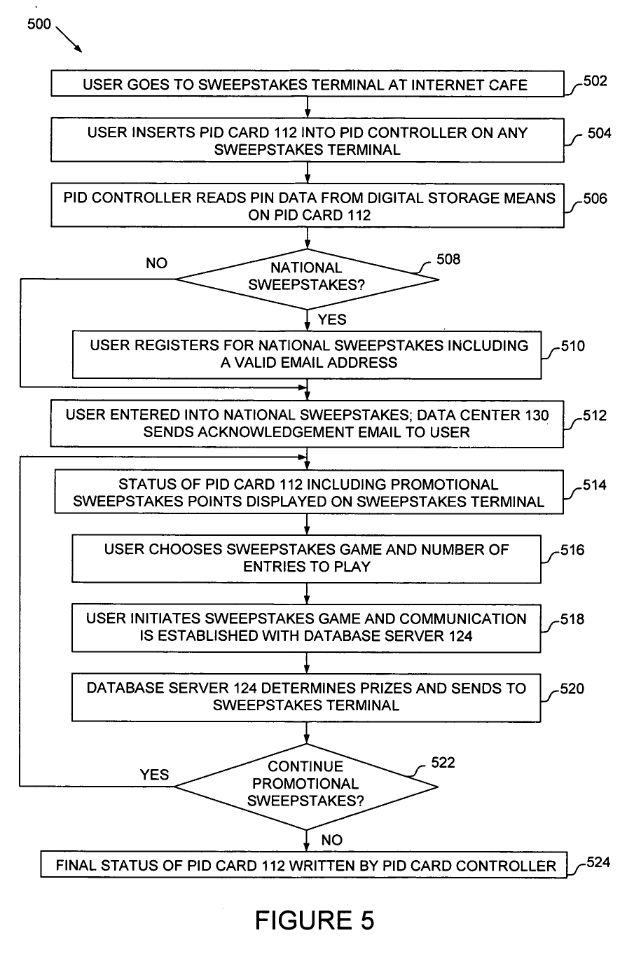

Returning to inquiry step 406, if the user decides to enter the optional sweepstakes, the procedure passes to a game participation step 414. Step 414 is explained in more detail below with respect to FIG. 5. After each play, the process continues with an inquiry step 416, in which a determination is made as to whether additional plays are available. If all of the free entry units have been played, then the process continues with inquiry step 410, in which the user decides whether to purchase additional access time and have PID card 112 reactivated with the additional access time and the additional entry into the national sweepstakes and the additional free entry units for the sweepstakes. On the other hand, if all of the free plays have not been played, the process continues with inquiry step 406, in which the user decides whether to continue to participate in the sweepstakes.

The process depicted by flowchart 400 may continue for as long as the user (1) maintains available access time on PID card 112; (2) maintains available free entries into the sweepstakes on PID card 112; or (3) recharges PID card 112 as provided for by POS terminal 120 or recharge terminal 115.

FIG. 5 is a high-level flow diagram 500, illustrating the operation of an exemplary sweepstakes game according to one embodiment of the present invention. Participation in the national and promotional sweepstakes begins with an initiation step 502 in which the user takes the PID card 112 to, for example sweepstakes terminal 117 in an internet cafe 110. It is understood that use of sweepstakes terminal 117 is but one way of playing a sweepstakes according to the present invention and that the present invention is not limited to the use of sweepstakes terminal 117, but may be one of any sweepstakes terminal associated with POS terminal 120. At step 504, the consumer inserts PID card 112 into PID card controller of sweepstakes terminal 117 located at internet cafe 110. Next, at step 506, PID card controller reads selected data from the digital storage means located on PID card 112. For example, PID card controller reads the amount of access time that was purchased, the purchase price of PID card 112, the personal identification number (PIN) assigned to PID card 112 during the activation step, the number of national sweepstakes entries, and the number of promotional sweepstakes entry units available for cases in which the number of promotional sweepstakes plays are not merely a calculated value corresponding to the amount of access time purchased.

The process continues with inquiry step 508, in which a determination is made as to whether the PIN associated with PID card 112 is registered for the national sweepstakes. The account for the PIN is located on database server 124 and the national sweepstakes registration is identified. If the user is already registered for the national sweepstakes, the process continues to step 512. On the other hand, if the user is not registered for the national sweepstakes, the process continues with step 510. At step 510, a registration form is launched at sweepstakes terminal 117 via a website, for example, “www.hello-money.com” in which the user registers for the national sweepstakes including the use of a valid email address. Sweepstakes terminal 117 accesses the internet data base server 124 via communication links 161 and 163 to internet 160. The website is maintained in web server 134 of data center 130. Then, at step 512, data center 130 acknowledges the user registration for the national sweepstakes in process step 510 or, if the user is already registered for the national sweepstakes from inquiry step 508, data center 130 sends an acknowledgment email to the user through the Internet via communications link 163.

Next, at step 514, the data read from PID card 112 is used by sweepstakes terminal 117 and the terminal-related software to display the status of PID card 112 including the quantity of promotional sweepstakes points. During step 514, selected images are displayed at selected portions of the video display of sweepstakes terminal 117 at selected times. As set forth above, the number of minutes of access time currently available on PID card 112 may be displayed on a first portion of the video display, the number or amount of promotional sweepstakes entries available on PID card 112 may be displayed on a second portion of sweepstakes terminal 115, the number or amount of credits or “wins” currently available on PID card may be displayed on a third portion of the video display, and the status of the current sweepstakes game in progress may be displayed on a fourth portion of the video display. In the preferred embodiment of the present invention, the fourth portion displays images of selected icons, both moving and stationary, so as to simulate the wheels of a slot machine. In particular, the images displayed in the fourth portion simulate an 8-liner gaming machine. Thus, the fourth portion may include physical or digitally displayed patterns indicating the eight different “pay” lines of an 8-liner machine.

Next, as represented by step 516, the user chooses one of several possible sweepstakes games to play. This step is possible because, in the preferred embodiment of the present invention, a plurality of promotional sweepstakes games may be conducted simultaneously by database server 124 and data center 130, with each sweepstakes game having a different style, genre, and/or graphical interface. For example, some users may prefer to play the sweepstakes using the 8-liner slot-machine type interface, while other users may prefer a draw poker interface. It will be appreciated that a wide variety of different sweepstakes game styles may be utilized; as such sweepstakes games are merely simulated by the game system software located at database server 124 and data center 130 and displayed on the sweepstakes terminals at internet cafe 110. In the preferred embodiment of the present invention, game selection step 516 is performed with the use of the touch-screen input feature of the display of sweepstakes terminal 117. In other words, when the user is ready to select a particular game type, the user merely depresses the portion of the video display that is displaying a graphical image depicting that sweepstakes game type.

Once a sweepstakes game type has been chosen by the user, step 516 continues in which the user chooses how many sweepstakes game entry units to play. The number of entry units may be expressed in numeric units, dollars and cents, or any other suitable units. In the preferred embodiment, the user's available entries are expressed in dollars and cents, with the minimum entry per play being $0.05, the maximum entry per play being $1.60, and with the entry being available in increments of $0.05. The user inputs the number of entry units to play by selecting the graphical image depicting the appropriate number of entry units to play. One of the graphical images displayed may be programmed to automatically enter the maximum number of entry units to play. As is common in such games, the higher the number of entries used, the higher the value of the prize, or the better the odds of winning particular prizes, if a prize is awarded.

The process continues with step 518, in which the user initiates the sweepstakes game. This is done by selecting one of the designated graphical images depicting the desired sweepstakes game. Initiation of the game causes the microprocessor and terminal-related software of sweepstakes terminal 117 to send signals and/or data over communication links 119c and 121 to database server 124. Also, after initiating the game, either the microprocessor and terminal-related software, database server 124, or data center 130 cause the video display of sweepstakes terminal 117 to initiate a simulation of the sweepstakes game being played. For example, if an 8-liner sweepstakes game had been chosen, graphical images or movies would be displayed to depict the wheels of a slot machine turning and then stopping at preprogrammed intervals.

Then, in calculation step 520, database server 124 calculates and determines how many, if any, prizes are to be awarded for that play. It is important to note that PID card 112 is not preprogrammed at the time of sale with any winning or losing combination of data. The user must choose to participate in the optional promotional sweepstakes and submit an entry via a sweepstakes terminal 117 in order to play the sweepstakes game and win any prizes. All calculations and determinations of prizes are conducted by database server 124 and are local promotional sweepstakes in response to entries made by users from sweepstakes terminal 117.

After database server 124 calculates and determines whether a prize has been won, the process continues, in which database server 124 transmits selected digital signals and data to the appropriate sweepstakes terminal 117 via communication links 121 and 119c. Once the data has been received by sweepstakes terminal 117, the microprocessor and terminal related software of sweepstakes terminal 117 cause corresponding audio and video messages, such as “You're a Winner!” to be displayed on the video display of sweepstakes terminal 117. In addition, the microprocessor and terminal-related software and/or database server 124 activate lights and speakers to enhance the experience of playing the sweepstakes game. After each sweepstakes game session, the process continues with an inquiry step 522, in which a determination is made as to whether the user wishes to continue to play the promotional sweepstakes. If the user decides to continue to play the promotional sweepstakes, the process continues back to step 514. On the other hand, if the user decides not to continue playing the promotional sweepstakes, the process continues with step 524.

Finally, as represented by step 524, when the user decides to end the sweepstakes game session, a button on sweepstakes terminal 117 is actuated, or in the case of a touch screen, the user merely depresses the portion of the video display that is displaying a graphical image depicting end sweepstakes game, thereby sending corresponding signals and data to database server 124 identifying that the user no longer wishes to participate in the game. This causes the PID card controller on sweepstakes terminal 117 to write the final status of PID card 112 to the digital storage means on PID card 112 and eject PID card 112 from the PID card controller. PID card 112 may then be used to access time for example to place telephone calls from any wired or wireless telephone, access the Internet from a remote location, utilize computer time, or the like.

It is understood that other operations can be implemented within the scope of the invention. It is also understood that the sequence of the operation shown can be varied without departing from the scope or principles of the present invention.

It is apparent that an invention with significant advantages has been described and illustrated. Although the present invention is shown in a limited number of forms, it is not limited to just these forms, but is amenable to various changes and modifications without departing from the spirit thereof.

What is claimed is:

1. For use in a sweepstakes network, a personal identification card capable of being purchased for goods and services unrelated to a sweepstakes, the personal identification card comprising:
a personal identification number associated with the personal identification card; and
readable and writeable digital storage for storing digital data related to the sweepstakes and the goods and services unrelated to the sweepstakes.

2. The personal identification card according to claim 1, wherein the personal identification card is capable of being activated by at least one point of sale terminal at one of a plurality of internet cafe sites.

3. The personal identification card according to claim 1, wherein the readable and writeable digital storage means is capable of storing the personal identification number.

4. The personal identification card according to claim 3, wherein the personal identification card is capable of data communication with at least one data center of the sweepstakes network for storing and retrieving data associated with the goods and services unrelated to the sweepstakes.

5. The personal identification card according to claim 3, wherein the personal identification card is capable of data communication with at least one access system of the sweepstakes network for storing and retrieving access time associated with the personal identification number.

6. The personal identification card according to claim 2, wherein the goods and services comprises:
at least one of prepaid telephone access time, prepaid wireless phone access time, prepaid internet access time, or prepaid computer use time at the internet cafe site.

7. The personal identification card according to claim 1, wherein the sweepstakes further comprises:
a national sweepstakes associated with each transaction using the personal identification card; and
a promotional sweepstakes associated with a fixed number of optional entries awarded for each corresponding value of access time purchased for the personal identification card.

8. A network for conducting a sweepstakes comprising:
a plurality of internet cafe sites capable of data communication with at least one personal identification card, the at least one personal identification card purchaseable for goods and services unrelated to the sweepstakes at the plurality of internet cafe sites;
a personal identification number associated with the at least one personal identification card;
readable and writeable digital storage means for storing digital data related to the sweepstakes and the goods and services unrelated to the sweepstakes;
at least one data center capable of data communication with the plurality of internet cafe sites and the at least one personal identification card; and
at least one access system capable of data communication with the plurality of internet cafe sites, the data center, and the at least one personal identification card.

9. The network according to claim 8, wherein at least one of the plurality of internet cafe sites further comprises:
at least one sweepstakes terminal capable of data communications with at least one point of sale terminal associated with the internet cafe.

10. The network according to claim 9, wherein the point of sale terminal comprises:
means for receiving currency;
readable and writeable means for accessing digital data associated with the at least one personal identification card;
means for activating the at least one personal identification card;
wherein, upon activation of the at least one personal identification card, an entry is provided into a national sweepstakes and a corresponding number of entry units is provided for corresponding goods and services purchased unrelated to the sweepstakes.

11. The network according to claim 9, wherein the sweepstakes terminal further comprises:
readable and writeable means for accessing digital data associated with the at least one personal identification card;
means for playing the sweepstakes;
means for updating the at least one personal identification card with the sweepstakes results; and
means is for data communication with at least one access system for storing and purchasing access time associated with the at least one personal identification card;
wherein upon purchase of access time from at least one of the at least one access system, an entry is provided into a national sweepstakes and a corresponding number of entry units is provided for corresponding access time purchased unrelated to the sweepstakes.

12. The network according to claim 9, wherein the internet cafe further comprises at least one recharge terminal in data communication with the point of sale terminal for recharging the at least one personal identification card with additional goods and services unrelated to the sweepstakes.

13. The network according to claim 12, wherein the recharge terminal comprises:
means for receiving currency;
readable and writeable means for accessing digital data associated with the at least one personal identification card; and
means for reactivating the at least one personal identification card;
wherein upon reactivation of the at least one personal identification card, an entry is provided into a national sweepstakes and a corresponding number of entry units is provided for corresponding goods and services purchased unrelated to the sweepstakes.

14. The network according to claim 9, wherein the goods and services unrelated to the sweepstakes are associated with the access system comprises at least one of prepaid telephone access time, prepaid wireless phone access time, prepaid internet access time, or prepaid computer use time at one of the plurality of internet cafe sites.

15. The network according to claim 14, wherein the sweepstakes further comprises:
a national sweepstakes associated with each transaction of the at least one personal identification card; and
a promotional sweepstakes associated with a fixed number of optional entries awarded for each corresponding value of access time purchased from the access system.

16. A method for conducting a sweepstakes comprising the steps of:
providing at least one personal identification card capable of being purchased for goods and services unrelated to a sweepstakes;
providing a personal identification number associated with the personal identification card;
providing readable and writeable digital storage means for storing digital data related to the sweepstakes and the goods and services unrelated to the sweepstakes;
providing a plurality of internet cafe sites capable of data communication with the at least one personal identification card;
providing at least one data center for storing and retrieving data associated with the at least one personal identification card and in data communication with the internet cafe;
providing at least one access system capable of data communication with the internet cafe, the data center, and the at least one personal identification card;
providing at least one point of sale terminal capable of data communication with at least one sweepstakes terminal associated with the internet cafe;
placing the sweepstakes terminals, the point of sale terminal, the internet cafe, the data center, the access system, and the means for activating and reactivating the at least one personal identification card in data communication;
providing an entry into a national sweepstakes and a corresponding number of entry units into a promotional sweepstakes;
playing the sweepstakes in response to a sweepstakes selection at the sweepstakes terminal; and
displaying the results of the sweepstakes selection on a video display of the sweepstakes terminal.

17. The method according to claim 16, further comprising the steps of:
providing means for reactivating the at least one personal identification card at one of a plurality of recharge terminals associated with the internet cafe; and
reactivating the at least one personal identification card for additional goods and services unrelated to the sweepstakes; and
providing an entry into a national sweepstakes and a corresponding number of entry units into a promotional sweepstakes.

18. The method according to claim 17, wherein the goods and services unrelated to the sweepstakes are associated with the access system and comprise at least one of prepaid telephone access time, prepaid wireless phone access time, prepaid internet access time, or prepaid computer use time.

19. The method according to claim 16, further comprising the steps of:
providing means for reactivating the at least one personal identification card at one of a plurality of sweepstake terminals associated with the internet cafe; and
reactivating the at least one personal identification card for additional goods and services unrelated to the sweepstakes; and
providing an entry into a national sweepstakes and a corresponding number of entry units into a promotional sweepstakes.

20. The method according to claim 19, wherein the goods and services unrelated to the sweepstakes are associated with the access system and comprise at least one of prepaid telephone access time, prepaid wireless phone access time, prepaid internet access time, or prepaid computer use time.
